(19) United States
(12) Patent Application Publication
(10) Pub. No.: US 2015/0262404 A1
(43) Pub. Date: Sep. 17, 2015

(54) Screen Content And Mixed Content Coding

(71) Applicant: Huawei Technologies Co., Ltd., Shenzhen (CN)

(72) Inventors: Thorsten Laude, Hannover (DE); Marco Munderloh, Langenhagen (DE); Joern Ostermann, Hannover (DE)

(21) Appl. No.: 14/645,136

(22) Filed: Mar. 11, 2015

Related U.S. Application Data
(60) Provisional application No. 61/952,160, filed on Mar. 13, 2014.

(51) Int. Cl. G06T 11/60; H04N 19/593; G06T 9/00; H04N 19/44

(52) U.S. Cl. CPC G06T 11/60; H04N 19/44; H04N 19/593; G06T 9/00

(57) ABSTRACT

An apparatus comprising a processor configured to obtain mixed content video comprising images comprising computer generated screen content (SC) and natural content (NC), partition the images into SC areas and NC areas, and encode the images by encoding the SC areas with SC coding tools and encoding the NC areas with NC coding tools, and a transmitter coupled to the processor, wherein the transmitter is configured to transmit data to a client device, the data comprising the encoded images and an indication of boundaries of the partition.

### CROSS-REFERENCE TO RELATED APPLICATIONS

The present application claims priority to U.S. Provisional Patent Application 61/952,160 filed Mar. 13, 2014 by Thorsten Laude, Marco Munderloh, and Joern Ostermann, and entitled “Improved Screen Content And Mixed Content Coding,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

With the recent growth of cloud-based services and the deployment of mobile devices such as smartphones and tablet computers as content display devices, new scenarios emerge where computer generated content is generated on one device but displayed using a second device. Further, such devices may be called upon to display camera captured content simultaneously with computer generated content, resulting in a need to display mixed content. Camera captured content and computer generated content have characteristics that differ significantly in terms of edge sharpness, amount of different colors, compression, etc. Video encoding and decoding mechanisms configured to display video captured content perform poorly when displaying computer generated content, and vice versa. For example, attempting to display computer generated content with a video encoding and decoding mechanism configured for video captured content may result in coding artifacts, blurring, excessive file size, etc. for the portion of the computer generated content portion of the display (and vice versa).

### SUMMARY

In one embodiment, the disclosure includes an apparatus comprising a processor configured to obtain mixed content video comprising images comprising computer generated screen content (SC) and natural content (NC), partition the images into SC areas and NC areas, and encode the images by encoding the SC areas with SC coding tools and encoding the NC areas with NC coding tools, and a transmitter coupled to the processor, wherein the transmitter is configured to transmit data to a client device, the data comprising the encoded images and an indication of boundaries of the partition.

In another embodiment, the disclosure includes a method of decoding mixed content video at a client device, the method comprising receiving a bit-stream comprising encoded mixed content video comprising images, wherein each image comprises SC and NC, receiving, in the bit-stream, an indication of boundaries of a partition between an SC area comprising SC content and an NC area comprising NC content, decoding the SC area bounded by the partition boundaries, wherein decoding the SC area comprises employing SC coding tools, decoding the NC area bounded by the partition boundaries, wherein decoding the NC area comprises employing NC coding tools that are different from the SC coding tools, and forwarding the decoded SC area and the decoded NC area to a display as decoded mixed content video.

In another embodiment, the disclosure includes a computer program product comprising computer executable instructions stored on a non-transitory computer readable medium such that when executed by a processor cause a network element (NE) to obtain mixed content video comprising images comprising SC and NC, partition the images into SC areas and NC areas, encode image data in the SC areas into at least one SC sub-stream, encode image data in the NC areas into at least one NC sub-stream, and transmit, via a transmitter, the sub-streams to a client device for recombination into the mixed content video.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment mixed content video comprising SC and NC.

FIG. 2 is a schematic diagram of an embodiment of a network configured to encode and deliver mixed content video.

FIG. 3 is a schematic diagram of an embodiment of an NE acting as a node in a network.

FIG. 4 is a flowchart of an embodiment of a method of encoding and delivering mixed content video.

FIG. 5 is a flowchart of an embodiment of a method of encoding and delivering mixed content video in a plurality of dedicated sub-streams.

FIG. 6 is a flowchart of an embodiment of a method of decoding mixed content video.

FIG. 7 is a schematic diagram of an embodiment of a method of quantization parameter (QP) management.

FIG. 8 illustrates another embodiment mixed content video comprising SC and NC.

FIG. 9 is a schematic diagram of example partition information associated with mixed content video.

FIG. 10 illustrates an embodiment of an SC segmented image comprising SC.

FIG. 11 illustrates an embodiment of an NC segmented image comprising NC.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following disclosure employs a plurality of terms which, in an embodiment, are construed as follows: Slice—a spatially distinct region of a frame that is independently encoded/decoded. Slice header—Data structure configured to signal information associated with a particular slice. Tile—a rectangular spatially distinct region of a frame that is independently encoded/decoded and forms a portion of a grid of such regions that divide the entire image. Block—an M×N (M-column by N-row) array of samples, or an M×N array of transform coefficients. Largest Coding Unit (LCU) grid—a grid structure employed to partition blocks of pixels into macro-blocks for video encoding. Coding Unit (CU)—a coding block of luma samples, two corresponding coding blocks of chroma samples of an image that has three sample arrays, or a coding block of samples of a monochrome picture or a picture that is coded using three separate color planes and syntax structures used to code the samples. Picture Parameter Set (PPS)—a syntax structure containing syntax elements that apply to zero or more entire coded pictures as determined by a syntax element found in each slice segment header. Sequence Parameter Set (SPS)—a syntax structure containing syntax elements that apply to zero or more entire coded video sequences as determined by the content of a syntax element found in the PPS referred to by a syntax element found in each slice segment header. Prediction Unit (PU)—a prediction block of luma samples, two corresponding prediction blocks of chroma samples of a picture that has three sample arrays, or a prediction block of samples of a monochrome picture or a picture that is coded using three separate color planes and syntax structures used to predict the prediction block samples. Supplemental enhancement information (SEI)—extra information that may be inserted into a video bit-stream to enhance the use of the video. Luma—information indicating the brightness of an image sample. Chroma—information indicating the color of an image sample, which may be described in terms of red difference chroma component (Cr) and blue difference chroma component (Cb). QP—a parameter comprising information indicating the quantization of a sample, where quantization indicates the compression of a range of values into a single value.

One possible scenario for mixed content video occurs when an application operates on a remote server with the display output forwarded to a local user workstation. Another example scenario is the duplication of a smartphone or tablet computer screen to a screen of a television device to allow a user to watch a movie on a larger screen than the mobile device screen. Such scenarios are accompanied by a need for an efficient transmission of SC, which should be capable of representing the SC signal with sufficient visual quality while observing data rate constraints given by existing transmission systems. An example solution for this challenge is to use video coding technologies to compress the SC, for example by employing video coding standards like Moving Pictures Expert Group (MPEG) version two (MPEG-2), MPEG version four (MPEG-4), Advanced Video Coding (AVC), and High Efficiency Video Coding (HEVC). HEVC is developed with the aim of compressing NC such as camera captured content, resulting in superior compression performance for NC, but poor performance for SC.

It is worth noting that NC and SC signals have characteristics that differ significantly in terms of edge sharpness, amount of different colors among other properties. Therefore some SC coding (SCC) methods may not perform well for NC and some HEVC coding tools may not perform well for SC. For instance, a HEVC coder either represents SC very poorly with strong coding artifacts such as blurred text and blurred edges or represents SC video with very high bit rates to allow the SC to be represented with good quality. In the event SCC mechanisms are employed to code an entire frame, such mechanisms perform well for the SC, but poorly describe the signal of the NC. One solution for this challenge is to enable or disable SCC tools and/or conventional coding tools on sequence and/or picture level if the sequence/picture contains only SC or NC. However, such an approach is not suitable for mixed content, which contains both natural as well as screen content.

Disclosed herein are various mechanisms for improved screen content and mixed content coding to support efficient and consistent quality display of mixed video content. Mixed video content is partitioned into NC areas and SC areas. The NC areas are encoded with NC specific coding tools, while SC areas are encoded with SC specific coding tools. Further, by employing differing QPs for different areas, NC areas may be encoded at lower resolution than SC areas to promote smaller file sizes without reducing the quality of the SC areas. Partition information is signaled to the client along with the encoded mixed content video, allowing the client to decode each area independently. The encoding entity (e.g. server) can also signal the client to enable/disable coding tools for each area, allowing for decrease processing requirements during decoding (e.g. unneeded coding tools can be turned off when not needed). In an alternate embodiment, each area (e.g. NC area or SC area) is encoded in a separate bit-stream/sub-stream of the video stream. The client can then encode each bit-stream and combined the areas to create composite images of both NC and SC content.

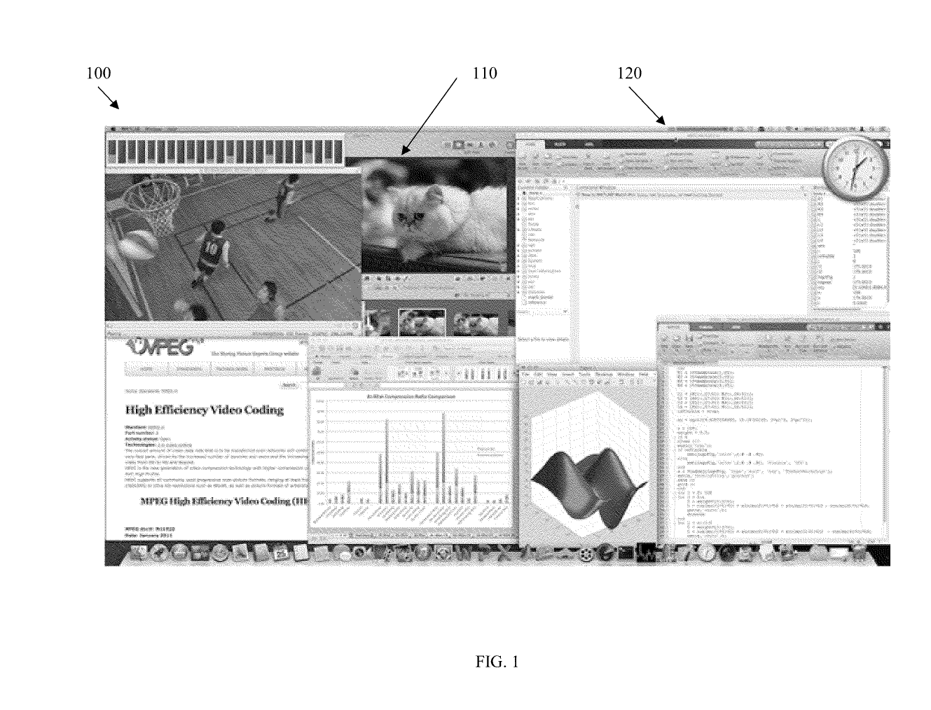

FIG. 1 illustrates an embodiment of mixed content video 100 comprising SC 120 and NC 110. A video sequence is a plurality of related images that make up a temporal portion of a video stream. Images may also be referred to as frames or pictures. Mixed content video 100 illustrates a single image from a video sequence. SC 120 is an example of SC. SC is visual output generated as an interface for a computer program or application. For example, SC may include web browser windows, text editor interfaces, email program interfaces, charts, graphs, etc. SC typically comprises sharp edges and relatively few colors often selected to contrast. NC 110 is an example of NC. NC is visual output captured by a video recording device or computer graphics generated to mimic captured video. For example, NC comprises real world images, such as sports games, movies, television content, internet videos, etc. NC also comprises computer graphics imagery (CGI) meant to mimic real world imagery such as video game output, CGI based movies, etc. Since NC displays or mimics real world images, NC comprises blurry edges and relatively large numbers of colors with subtle changes in adjacent colors. As can be seen mixed content video 100, globally employing coding tools designed for NC on video 100 will result in poor performance for SC 120. Further, globally employing coding tools designed for SC on mixed content video 100 will result in poor performance for NC 110. It should be noted that the term coding tools, as used herein, includes both encoding tools for encoding content and decoding tools for decoding content.

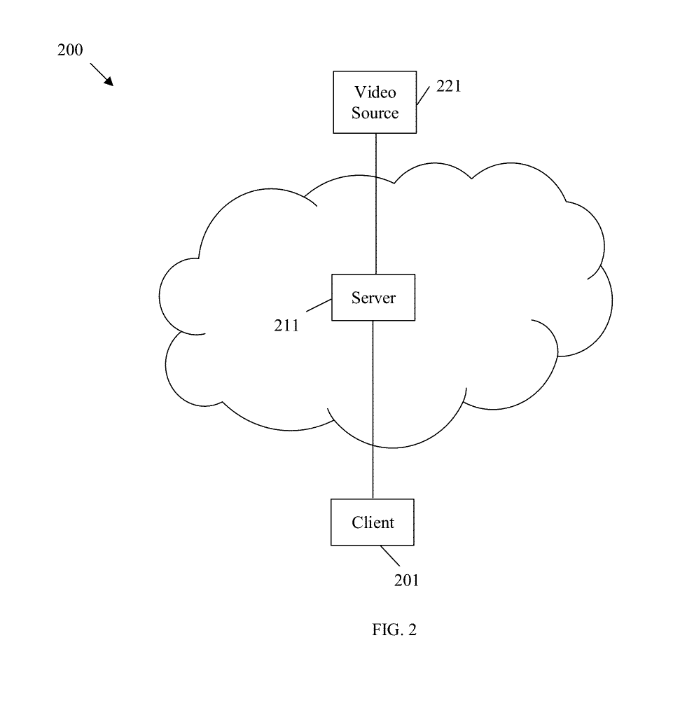

FIG. 2 is a schematic diagram of an embodiment of a network 200 configured to encode and deliver mixed content video, such as mixed content video 100. Network 200 comprises a video source 221, a server 211, and a client 201. The video source 221 generates both NC and SC and forwards them to the server 211 for encoding. In an alternate embodiment, video source 221 may comprise a plurality of nodes that may not be directly connected. In another alternate embodiment, the video source 221 may be co-located with the server 211. As an example, video source 221 may comprise a video camera configured to record and stream real time video and a computer configured to stream presentation slides associated with the recorded video. As another embodiment, the video source 221 may be a computer, mobile phone, tablet computer, etc. configured to forward the contents of an attached display to the server 211. Regardless of the embodiment, the SC content and the NC content are forwarded to the server 211 for encoding and distribution to the client 201.

The server 211 may be any device configured to mixed video content as discussed herein. As non-limiting examples, the server 211 may be located in a cloud network as depicted in FIG. 2, may be located as a dedicated server in a home/office, or may comprise the video source 221. Regardless of the embodiment, the server 211 receives the mixed content video and partitions the frames of the video, and/or sub-portions of the frames, into one or more SC areas and one or more NC areas. The server 211 encodes the SC areas and the NC areas independently, by employing SC coding tools for the SC areas and NC tools for the NC areas. Further, resolutions of the SC areas and NC areas may be modified independently to optimize the video for file size and resolution quality. For example, compression of NC has a greater effect on file size than compression of SC because NC video is generally significantly more complex than SC video. As such, NC video may be significantly compressed without significantly compressing the SC video, which may result in reduced file size without overly reducing the quality of the SC video. The server 211 is configured to transmit the encoded mixed video content toward the client 201. In an embodiment, the video content may be transmitted as a bit-stream of frames that each comprise SC encoded area(s) and NC encoded area(s). In another embodiment, the SC area(s) are encoded in SC sub-stream(s) and the NC areas are encoded in NC sub-stream(s). The sub-streams are then transmitted to the client 201 for combination into composite images. In either embodiment, the server 211 is configured to transmit data to the client 201 to assist the client 201 in decoding the mixed video content. The data transmitted to the client 201 comprises partition information indicating boundaries of each SC and NC area. The data may also comprise implicit or explicit indications of the coding tools to be enabled or disabled for each area. The data may also comprise QPs for each area, where the QPs describe the compression of each area.

The client 201 may be any device configured to receive and decode mixed content video. The client 201 may also be configured to display the decoded content. For example, the client 201 may be a set top box coupled to a television, a computer, a mobile phone, tablet computer, etc. The client 201 receives the encoded mixed video content, decodes the mixed video content based on data received from the server (e.g. partition information, coding tool information, QPs, etc.), and forwards the decoded mixed video content for display to an end user. Depending on the embodiment, the client 201 decodes each area of each frame based on the partition information or decodes each sub-stream and combines the areas from each sub-stream into composite images based on the partition information.

By partitioning mixed content video into SC areas and NC areas, each area can be independently encoded by employing mechanisms most appropriate for the associated area. Such partitioning solves the problem of differing image processing requirements for NC areas and SC areas in the same image. Partitioning and treating each area independently alleviates the need for a highly complex coding system to simultaneously process both NC and SC image data. Multiple mechanisms exist to partition the areas, transmit the partition data, enable/disable coding tools, signal quantization, and forward encoded mixed video content to the client 201, which are discussed in greater detail herein below.

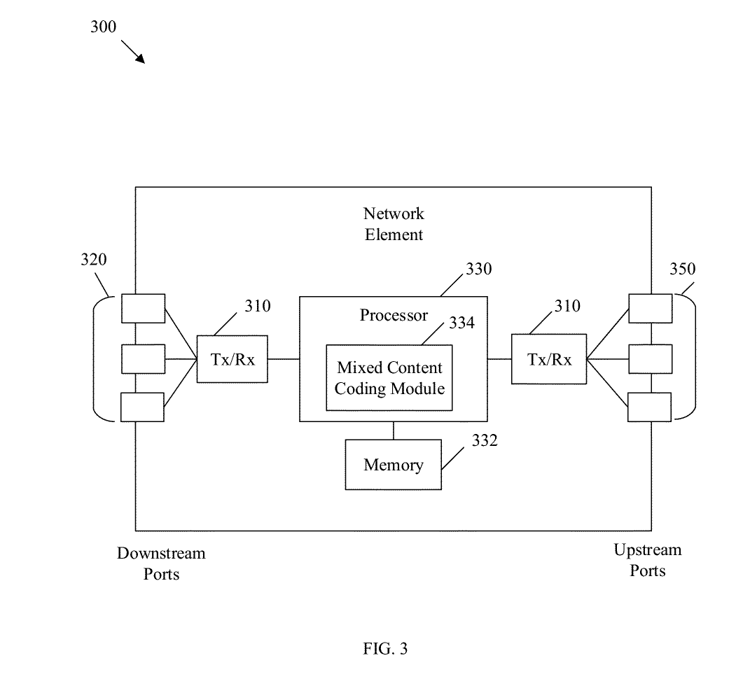

FIG. 3 is a schematic diagram of an embodiment of an NE 300 acting as a node in a network, such as server 211, client 201, and/or video source 221, and configured to code and/or decode mixed content video such as mixed content video 100. NE 300 may be implemented in a single node or the functionality of NE 300 may be implemented in a plurality of nodes in a network. One skilled in the art will recognize that the term NE encompasses a broad range of devices of which NE 300 is merely an example. NE 300 is included for purposes of clarity of discussion, but is in no way meant to limit the application of the present disclosure to a particular NE embodiment or class of NE embodiments. At least some of the features/methods described in the disclosure may be implemented in a network apparatus or component such as an NE 300. For instance, the features/methods in the disclosure may be implemented using hardware, firmware, and/or software installed to run on hardware. The NE 300 may be any device that transports frames through a network, e.g. a switch, router, bridge, server, a client, video capture device, etc. As shown in FIG. 3, the NE 300 may comprise transceivers (Tx/Rx) 310, which may be transmitters, receivers, or combinations thereof. A Tx/Rx 310 may be coupled to plurality of downstream ports 320 (e.g. downstream interfaces) for transmitting and/or receiving frames from other nodes and a Tx/Rx 310 coupled to plurality of upstream ports 350 (e.g. upstream interfaces) for transmitting and/or receiving frames from other nodes, respectively. A processor 330 may be coupled to the Tx/Rxs 310 to process the frames and/or determine which nodes to send frames to. The processor 330 may comprise one or more multi-core processors and/or memory devices 332, which may function as data stores, buffers, etc. Processor 330 may be implemented as a general processor or may be part of one or more application specific integrated circuits (ASICs) and/or digital signal processors (DSPs). Processor 330 may comprise a mixed content coding module 334, which may perform methods 400, 500, 600, and/or 700, depending on the embodiment. In an embodiment, the mixed content coding module 334 partitions SC and NC areas, encodes mixed content video based on the partitions, and signals partition information, encoding tool information, quantization information, and/or encoded video to a client. In another embodiment, the mixed content coding module 334 receives and decodes mixed video content based on partition and related information received from a server. In an alternative embodiment, the mixed content coding module 334 may be implemented as instructions stored in memory 332, which may be executed by processor 330, for example as a computer program product. In another alternative embodiment, the mixed content coding module 334 may be implemented on separate NEs. The downstream ports 320 and/or upstream ports 350 may contain electrical and/or optical transmitting and/or receiving components.

It is understood that by programming and/or loading executable instructions onto the NE 300, at least one of the processor 330, mixed content coding module 334, downstream ports 320, Tx/Rxs 310, memory 332, and/or upstream ports 350 are changed, transforming the NE 300 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

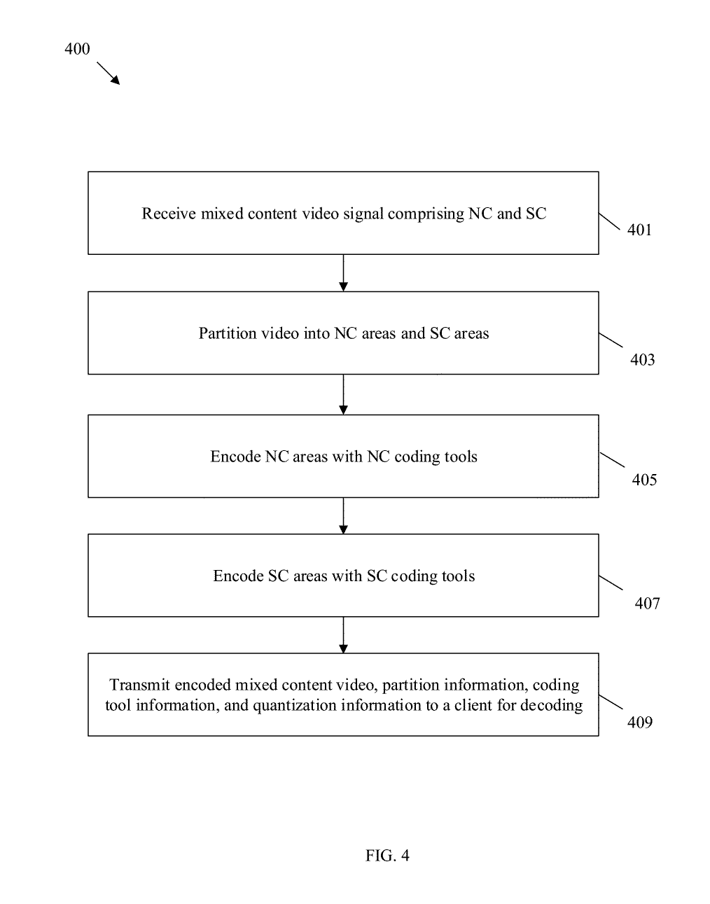

FIG. 4 is a flowchart of an embodiment of a method 400 of encoding and delivering mixed content video, such as mixed content video 100. Method 400 may be implemented by a network device such as server 211 and/or NE 300 and may be initiated by receiving video content to be encoded as mixed content video. At step 401, a mixed content video signal is received that comprises NC and SC, for example from video source 221. At step 403, the video is partitioned into NC areas and SC areas. Partition decisions may be made based on data received from a video source of the NC video images and/or on data received from a processor creating SC images, such data indicating locations of the NC and the SC in the frames. In an alternate embodiment, the method 400 may examine the frame to determine SC and NC locations prior to partitioning.

Multiple mechanisms can be used to partition the NC areas and the SC areas. For example, the areas may be partitioned into square shaped areas or rectangular shaped areas. In an embodiment, pixel coordinates are used to describe the borders of the partitions. As examples, the coordinates are expressed by the horizontal and vertical components of the top-left and the bottom-right position of the NC areas, the SC areas or both. As other examples, coordinates are expressed by the horizontal and vertical components of the bottom-left and the top-right position of the NC areas, the SC areas, or both. In another embodiment, each image is quantized into a grid where the minimum distance between two points is bigger than a full pixel distance, such as a LCU grid corresponding to HEVC macroblocks or a CU grid employed for predictional coding. Grid coordinates are then used to describe the borders of the partitions. The coordinates can be expressed by the horizontal and vertical components of the top-left and the bottom-right position of the NC areas, the SC areas or both. The coordinates can also be expressed by the horizontal and vertical components of the bottom-left and the top-right position of the NC areas, the SC areas or both. The different partitioning possibilities are motivated by a trade-off between signaling overhead and precision of the area borders. If exact coordinates are used to describe the dimensions of the areas the border of the partition may be set exactly at the position in the image where the SC ends and the NC begins. However, taking into account that coding tools may operate block-wise, the partitioning may be applied to cause the partition borders to match the block sizes employed by the associated coding tools. If the borders of an area may only be expressed on a larger grid, for instance in multiples of the LCU or CU size, an SC area may contain some rows and/or columns of NC at the area borders and vice versa. On the other hand a larger grid would introduce less signaling overhead.

As another example, the areas may be partitioned into arbitrary shaped areas. If the areas have an arbitrary shape they may be better fitted to the content of the frame. However, the description of arbitrary shapes as syntax elements requires more data than rectangular or square shaped areas. When employing arbitrary shaped area, such areas can be mapped to a square or rectangular grid. Such mapping may support use of block based coding tools. Such a mapping process may also be applied if the NC and/or SC areas are expressed on a grid, such as an LCU grid, when some sub-CUs of an LCU belong to a SC area while other sub-CUs of the same LCU belong to an NC area. For example, a block may be interpreted as part of a mapped NC area when at least one sample of the block comprises NC, when all samples of the block comprise NC, or when a ratio of NC samples to SC samples in a block exceeds a predetermined threshold (e.g. seventy five percent, fifty percent, twenty five percent, etc.) In other examples, a block may be interpreted as part of a mapped SC area when at least one sample of the block comprises SC, when all samples of the block comprise SC, or when a ratio of SC samples to NC samples in a block exceeds a predetermined threshold (e.g. seventy five percent, fifty percent, twenty five percent, etc.) Further, small blocks, such as 4×4 blocks, and/or a fine non-pixel based grid can be used to better fit the area boundaries in order to reduce the number of samples incorrectly mapped to an NC or SC area.

Partitioning may also be employed across multiple frames. For example, a partition may be created at the beginning of an encoding of a sequence and remain valid for the whole sequence without changes. A partition may also be made created at the beginning of an encoding of a sequence and remain valid until a new partition is needed, for example due to an event (e.g. a resizing of a window in the mixed video content), expiration of a time, and/or after encoding a predetermined number of frames. Implementation of partition embodiments is based on the trade-off between efficiency and complexity. The most efficient partitioning scheme might involve partitioning each entire frame at the same time. Restricting partitioning to small areas of each frame might allow for increased encoding parallelization.

At step 405, the NC areas are encoded with NC tools based on the partitions. At step 407, the SC areas are encoded with SC tools based on the partitions. Some NC tools may not be beneficial for SC areas, and some SC tools may not be beneficial for NC areas. Accordingly, NC areas and SC areas are encoded independently based on different coding tools. Further, most SC areas can be coded very efficiently, while significantly higher bitrates may be required to describe the NC areas. In order to comply with data rate requirements of an associated transmission or storage system, a reduction in the data rate of the mixed video content bit-stream may be required. Taking into account the characteristics of the human visual perception system with respect to the cognition of coding errors in SC and NC, data rate reduction during encoding may be employed separately for NC and SC areas. For example, small quality degradations may be perceivable in SC areas while being imperceptible in NC areas. Accordingly, NC and SC areas of the images may be encoded by employing representations with different quality for different areas. In an embodiment, different QPs may be employed for NC and SC areas. As a specific example, higher QPs may be employed for NC areas than SC areas, resulting coarser quantization for NC areas than for SC areas. NC areas may be responsible for a major fraction of the overall data rate of the mixed content video due to the large number of colors and shading in the NC areas. As such, employing higher QPs for NC areas and lower QPs for SC areas may significantly reduce the overall data rate of the mixed content video while maintaining high visual quality in SC areas and reasonably high perceivable visual quality in the NC areas. Other mechanisms may also be applied to achieve representations of different quality for NC and SC areas. For instance, different QP values may be employed for each NC and/or SC area rather than having one QP value for all NC areas and one QP value for all SC areas. Furthermore, different QP offsets may be employed for each chroma component of the SC and/or NC areas.

At step 409, the encoded mixed content video, partition information, coding tool information, and quantization information is transmitted to a client for decoding. There are multiple embodiments for signaling the partition information. For example, the SC area partitions, NC area partitions, or both, can be transmitted as part of the bit-stream(s) along with the encoded mixed video content. Partition information may be signaled at the beginning of a sequence, whenever partitioning changes, for each picture/image, for each slice of the sequence, for each tile of the sequence, for each block of the sequence (e.g. for each LCU or CU), and/or for each arbitrarily shaped area. Once the SC areas and NC areas have been determined, they may be signaled as part of the encoded mixed content video bit-stream. In various embodiments, partition information, coding tool information, and/or quantization information can be signaled as part of the videos Picture Parameter Set (PPS), Sequence Parameter Set (SPS), slice header, with CU level information, with prediction unit (PU) level information, with Coding Tree Unit (TU) level information, and/or in supplemental enhancement information (SEI) message(s). Other forms of partition may also be used such as specifying a corner of an NC and/or SC by a corner location along with a width and height of the area. Signaling overhead may be reduced by employing NC and/or SC areas from a previous image to predict NC and/or SC areas for subsequent images. For example, all NC and/or SC areas may be copied from previous images; some NC and/or SC areas may be signaled explicitly while some NC and/or SC areas are copied from previous images; or relative changes between NC and/or SC areas of a previous image and NC and/or SC areas of current image may be signaled (e.g. when NC and/or SC areas change in location and/or size).

In some embodiments, the client may determine which coding tools to employ implicitly based on the partition information (e.g. SC tools for SC areas and NC tools for NC areas). In another embodiment, signaling of coding tool information is employed to disable and/or enable coding tools for NC areas and/or SC areas at the client. In some cases the decision to enable or disable a coding tool may not be based solely on a determination of whether a sample of the image belongs to a NC area or an SC area. For example, signaling to enable/disable coding tools may be beneficial when the NC and/or SC areas are arbitrary shaped. When applied to the arbitrarily shaped area, block based coding tools may be applied to both sides of an area boundary causing the tools be applied to by NC and SC. The client may not have enough information to determine whether to use SC coding tools or NC coding tools for the area. Accordingly, coding tools to be enabled/disabled for an area can be signaled explicitly or determined implicitly by the client. The client may then enable or disable coding tool(s) for the area(s) based on the coding tool information and/or based on the partition information. As another example, complexity at the encoding steps 405 and/or 407 may be reduced when specific coding tools are disabled for specific areas of an image. Reducing the complexity of the encoding steps may reduce costs, power consumption, delay, and benefit other properties of the encoder (e.g. server). For example, encoding complexity may be reduced by limiting mode decision processes and rate-distortion optimizations that are not beneficial for particular content in a particular SC and/or NC area, which may require signaling. Further, some mode decision processes and rate-distortion optimizations may never be beneficial for a particular type of content and may be determined implicitly or signaled. For example, transform coding methods may be disabled for all SC areas and palette coding method may be disabled for all NC areas. As another example, differing chroma sampling formats may be signaled for NC areas and/or SC areas.

Quantization information may also be signaled to the client in a manner substantially similar to partition information and/or coding tool information. For example, different QP values for NC and/or SC areas may be inferred implicitly or signaled as part of the mixed content video bit-stream. QP values for SC and/or NC areas may be signaled as part of the PPS, SPS, slice header, CU level information, PU level information, TU level information, and/or as a SEI message.

By transmitting encoded mixed content video, partition information, coding tool information, and quantization information as discussed herein, the method 400 may treat each SC area and NC area separately during encoding to create an efficiently encoded mixed video content bit-stream that can be decoded by a client device.

It should be noted that the steps of method 400 are depicted in order for simplicity of discussion. However, it should be understood that method 400 may be performed in a continuous loop to encode a plurality of images as part of a video sequence. Further, the steps of method 400 may be performed out of order depending on the embodiment. For example, step 403 may be performed multiple times in a loop for a fine grain partition of a frame or once for a plurality of loops when a partition is employed for multiple frames. Further, steps 405 and 407 may be performed in either order or in parallel. Further, the transmissions of step 409 may occur after all encoding is complete or in parallel with the other steps of method 400, depending on the embodiment. Accordingly, the order of method 400 as depicted in FIG. 4 should be considered explanatory and non-limiting.

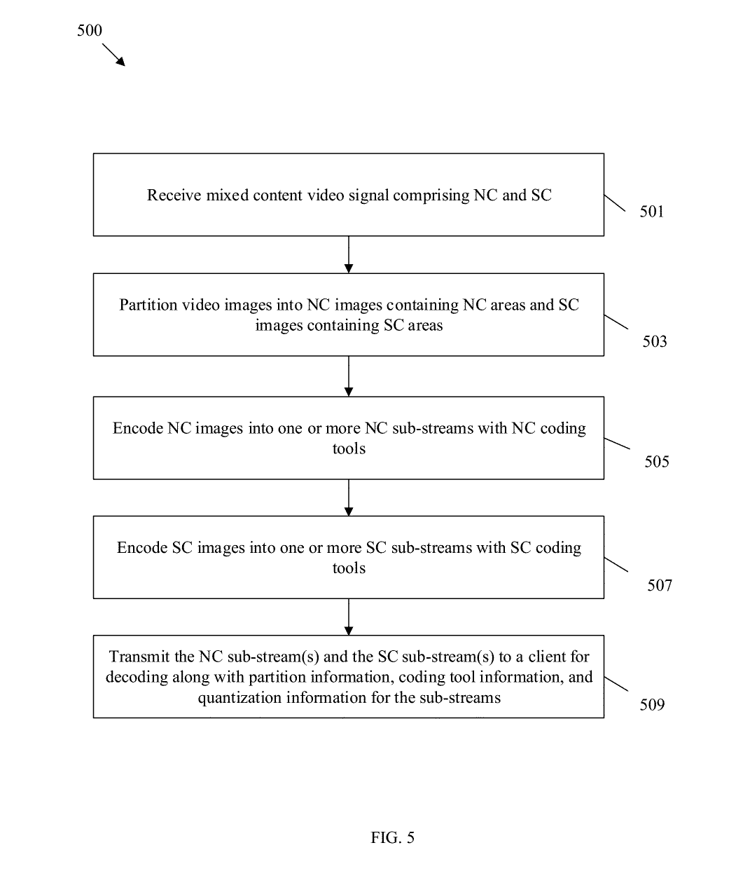

FIG. 5 is a flowchart of an embodiment of a method 500 of encoding and delivering mixed content video, such as mixed content video 100, in a plurality of dedicated sub-streams. Method 500 may be employed by a server, such as server 211, and is substantially similar to method 400 (and hence is implemented under similar conditions), but employs dedicated bit-streams for each area of the mixed content video images. Such bit-streams are referred to herein as sub-streams. At step 501, mixed content video is received in a manner substantially similar to step 401. At step 503, the video images are partitioned into NC images containing NC areas and SC images containing SC areas. For example, each image is partitioned into NC areas and SC areas in a manner similar to step 403. Each NC area is segmented into an NC image, and each SC area is segmented into an SC image. At step 505, the NC images are encoded into one or more NC sub-streams with NC coding tools. At step 507, the SC images are encoded into one or more SC sub-streams with SC coding tools. At step 509, the NC sub-stream(s) and the SC sub-stream(s) are transmitted to a client, such as client 201, for decoding along with partition information, coding tool information, and quantization information for the sub-streams in a manner similar to step 409.

As with method 400, method 500 may be deployed in multiple embodiments. For example, a single NC sub-stream may be employed for all NC areas, while a single SC sub-stream may be employed for all SC areas. Further, NC areas and/or SC areas may each be further subdivided with each sub-area being assigned to a separate sub-stream. Also, some sub-areas may be combined in a sub-stream, while other sub-areas are assigned to dedicated sub-streams, for example by grouping such sub-areas based on quantization, coding tools employed, etc. By segmenting each mixed content image into multiple images, each segmented image can be encoded independently and sent to the client for combination into a composite image.

In an embodiment, each sub-stream may be encoded at steps 505 and/or 507 to have a different resolution. For example, the resolutions of the sub-streams may correspond to the size of the corresponding NC and SC areas, respectively. The resolution of the sub-streams and/or a mask may be employed to define how the sub-streams shall be composed at the decoder to generate the output. The resolution and/or mask may be transmitted at step 509 as partition information, for example by employing protocols such as MPEG-4 Binary Format for Scenes (BIFS) and/or MPEG Lightweight Application Scene Representation (LASeR). In another embodiment, all the sub-streams may employ equal resolution, which may allow for easier combination of the sub-streams at the client/decoder. In such a case the sub-streams may be combined by applying a mask that indicates which areas shall be extracted from which sub-stream. The area extraction may be followed by a composition of the areas to the final picture.

In embodiments where multiple areas are encoded into multiple sub-streams, some areas may not comprise image content at all times, for example when a window is resized, closed, etc. during a mixed content video sequence. In such cases, the associated sub-stream(s) may not carry image data at all times. In order to ensure proper decoding, a defined/default value may be assigned and/or signaled to assist the decoder in combining the sub-streams into the correct composite image. For example, when a sub-stream comprises no mapped content, the associated samples may be assigned a fixed value (e.g. 0) at steps 505 and/or 507, which may represent a uniform color (e.g. green). The fixed value/color may be employed as mask information during decoding.

As another embodiment, areas with mapped content may be expanded into the areas with no mapped content during the encoding of steps 505 and/or 507. For example, such an embodiment may be employed when the size and/or position of the areas in the sub-streams are not aligned with the CU or block grid of the associated coding systems. Accordingly, the areas may be expanded to the associated grid for ease of decoding. Further, when a content area is non-rectangular, the content area may be expanded into a rectangular shaped area. The expansion may involve duplication of edge samples from areas with mapped content and/or the interpolation based on samples of areas with mapped content. Directional expansion methods may also be employed. For instance, HEVC intra prediction methods may be applied to expand the areas with mapped content into the areas without mapped content.

It should be noted that NC areas may comprise previously encoded content, such as received content that is already compressed by other video coding standards. For example, a first portion of an NC area could comprise a compressed video in a first software window, while compressed images (e.g. Joint Photographic Experts Group (JPEGs)) could be displayed in a second window. Re-encoding previously encoded content may result in negative efficiency and increased data loss. Accordingly, areas comprising previously encoded material may employ the original compressed bit-stream for the sub-stream associated with these areas.

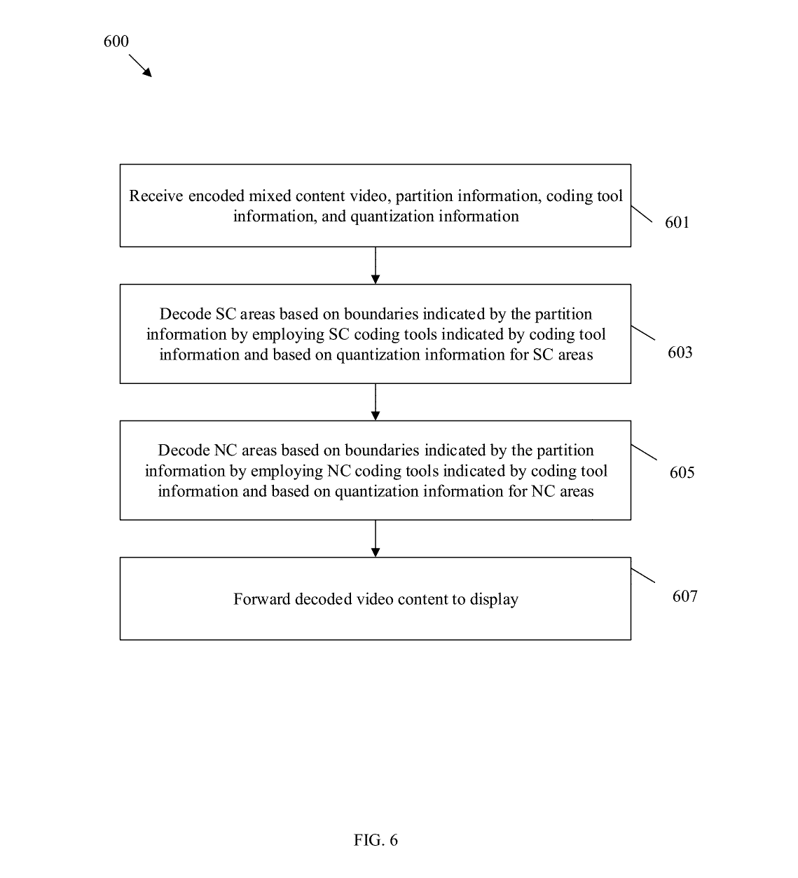

FIG. 6 is a flowchart of an embodiment of a method 600 of decoding mixed content video, such as mixed content video 100. Method 600 may be employed by a client, such as client 201, and is initiated upon receiving encoded mixed content video (e.g. from a server 211). At step 601, encoded mixed content video, partition information, coding tool information, and/or quantization information is received, for example from a server 211 as a result of steps 409 or 509. At step 603, SC areas are decoded based on boundaries indicated by the partition information by employing SC coding tools indicated by coding tool information and based on quantization information for SC areas. For example, the location and size of each area may be determined by the partition information received at step 601. The coding tools to be enabled and/or disabled may be determined by explicit coding tool information or implicitly based on the partition information. The SC areas may then be decoded by applying the determined/signaled coding tools to the SC areas based on their location/size (e.g. partition boundaries) and based on any quantization/QP values received at step 601. At step 605, NC areas are decoded based on boundaries indicated by the partition information by employing NC coding (NCC) tools indicated by coding tool information and based on quantization information for NC areas in a manner substantially similar to step 603. In embodiments where the SC areas and NC areas are received in a plurality of dedicated sub-streams, steps 603 and 605 further comprise combining the decoded areas into for each image into a composite image based on the partition information. At step 607, the decoded mixed video content is forwarded toward a display. As with methods 400 and 500, the steps of method 600 may be performed out of order and/or in parallel as needed to decode the received video.

To further clarify partition information signaling, coding tool signaling, and/or quantization signaling in methods 400, 500, and 600, it should be noted that a decoder (e.g. client 201) may be aware of different content types (e.g. NC and/or SC), in a signal and the position of the NC and/or SC areas in the images, for example based on signaling, signal analysis at the decoder, etc. The coding tools to be enabled/disabled at the decoder based on explicit signaling or implicitly based on the partition information indicating the SC area(s) and NC area(s). When a coding tool is disabled, the decoder may not expect syntax elements associated with the disabled coding tool in the associated bit-stream and/or sub-stream. For example, the decoder may disable transform coding for blocks within SC areas. Specifically, transform_skip_flag[x0][y0][cldx] may not be present in an associated bit-stream, but may be inferred by the decoder as 1 for some or all color components in the area. The array indices x0, y0 specify a location (x0, y0) of a top-left luma sample of a considered transform block relative to the top-left luma sample of the image. The array index cldx specifies an indicator for the color component, e.g. equal to 0 for luma, equal to 1 for Cb, and equal to 2 for Cr. The decoder may also use different chroma sampling formats associated with NC and SC areas. Chroma sampling format employs a notation J:a:b, where J indicates a width of a sampling region (e.g. in pixels, grid coordinates, etc), a indicates a number of chrominance samples in a first row of the sampling region, and b indicates a number of changes in chrominance samples between the first row of J and a second row of J. 4:2:0 sampling format may be sufficient to meet the needs and capabilities of the human visual perception system for NC, while 4:4:4 sampling format may be employed for SC. In an embodiment, 4:4:4 sampling format may employed for SC areas of an image and 4:2:0 sampling format may be employed for NC areas of the image. Chroma sampling formats may be determined by the decoder implicitly based on the partition information or may be received as a type of coding tool information. Such chroma sampling format information can be signaled as part of the videos PPS, SPS, slice header, with CU level information, with PU level information, with TU level information, and/or in SEI message(s).

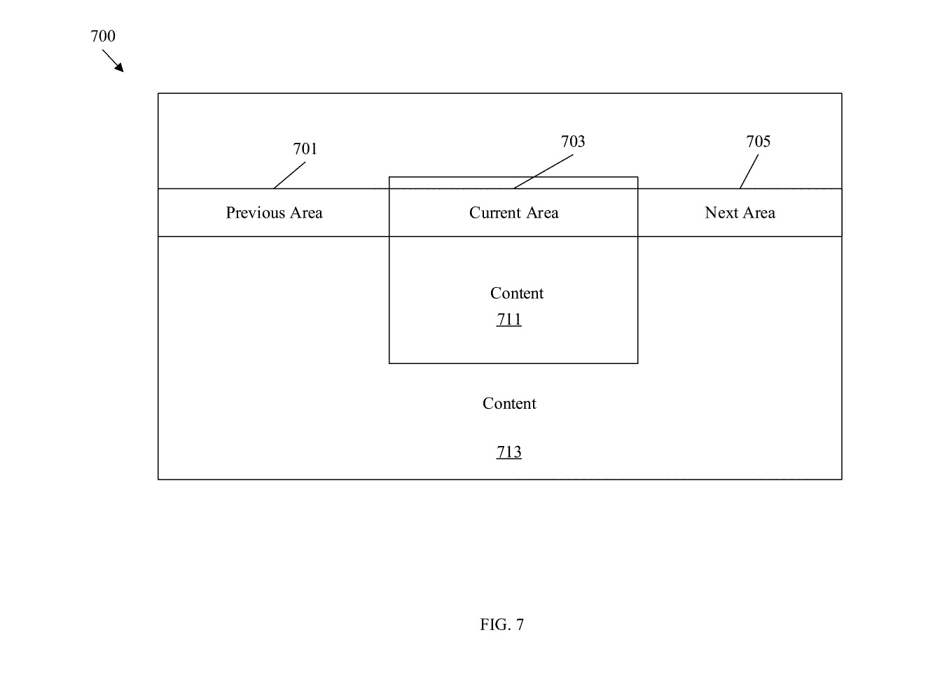

FIG. 7 is a schematic diagram 700 of an embodiment of a method of QP management, which may be employed in conjunction with methods 400, 500, and/or 600. As discussed above, different QP values may be signaled for NC and/or SC areas as quantization information. A decoder may decode an image from left to right (or vice versa) and top to bottom (or vice versa). Since an SC areas may surround an NC area (or vice versa), a decoder, such as client 201 may be required to repeatedly change QP values when moving from area to area. Decoding, for example in steps 603 and 605, may be improved by re-establishing a previously employed QP value when moving between areas. Diagram 700 comprises content 711 (e.g. NC content) and content 713 (e.g. SC content). Content 711 and 713 require different QP values for appropriate decoding. When decoding, the decoder may decode a previous area 701 first, then a current area 703, and then a next area 705. Upon completion of decoding the previous area 701, the QP value for the previous area 701 may be stored for use as a predictor of the QP value for next area 705, because areas 701 and 705 both comprise content 713 in the same content area. The QP value for the current area 703 may then be employed during decoding of the current area. Upon completion of current area 703, the decoder may re-establish the last QP value used (e.g. for previous area 701) in the previous quantization group/content area (in decoding order) as a predictor for the QP value in the next quantization group/content area (in decoding order). Further, the QP value of the current area 703 may also be stored prior to decoding the next area 705, which may allow the QP value of the current area 703 to be re-established when the decoder returns to content 711. By re-establishing QP values between content areas, the decoder can toggle between QP values when moving between content areas.

As discussed hereinabove, partition information, and quantization information may be signaled and/or inferred by employing a plurality of mechanisms. Disclosed are specific example embodiments that may be employed to signal such information. Table 1 describes specific source code that may be employed to signal partition information related to NC areas in a slice header via HEVC Range Extensions text specification: draft 6 by D. Flynn, et. al, which is incorporated by reference.

TABLE 1

De-
scriptor

```
  slice_segment_header( ) {
...
  if( !dependent_slice_segment_flag ) {
...
```

if( pps_loop_filter_across_slices_enabled_flag &&
( slice_sao_luma_flag | | slice_sao_chroma_flag | |

!slice_deblocking_filter_disabled_flag ) )

| | |
|---|---|
| slice_loop_filter_across_slices_enabled_flag | u(1) |
| nc_areas_enabled_flag | u(1) |
| if( nc_areas_enabled_flag ) { | |
| number_nc_areas_minus1 | u(v) |
| for( i = 0; i < number_nc_areas_minus1 + 1; i++ ) { | |

| | |
|---|---|
| nc_area_left_list_entry[i] | u(v) |
| nc_area_top_list_entry[i] | u(v) |
| nc_area_width_list_entry[i] | u(v) |
| nc_area_height_list_entry[i] | u(v) |

}
}

```
  }
  if( tiles_enabled_flag | |
  entropy_coding_sync_enabled_flag ) {
```

| | |
|---|---|
| num_entry_point_offsets | ue(v) |
| if( num_entry_point_offsets > 0 ) { | |
| offset_len_minus1 | ue(v) |
| for( i = 0; i < num_entry_point_offsets; i++ ) | |

| | |
|---|---|
| entry_point_offset_minus1[ i ] | u(v) |

}

```
  }
  if( slice_segment_header_extension_present_flag ) {
```

| | |
|---|---|
| slice_segment_header_extension_length | ue(v) |
| for( i = 0; i < slice_segment_header_extension_length; | |
| i++) | |
| slice_segment_header_extension_data_byte[ i ] | u(8) |

```
  }
  byte_alignment( )
}
```

As shown in table 1, nc_areas_enabled_flag may be set equal to 1 to specify that signaling of NC areas is enabled for the slice, and nc_areas_enabled_flag may be set equal to 0 to specify that no NC areas are signaled for the slice. number_nc_areas_minus 1 plus 1 may specify the number of NC areas which are signaled for the slice. nc_area_left_list_entry[i] may specify the horizontal position of the top-left pixel of the i-th NC area. nc_areas_top_list_entry[i] may specify the vertical position of the top-left pixel of the i-th NC area. nc_area_width_list_entry[i] may specify the width of the i-th NC area. nc_area_height_list_entry[i] may specify the height of the i-th NC area.

Table 2 describes specific source code that may be employed to signal partition information related to SC areas in a slice header via HEVC Range Extensions text specification: draft 6.

TABLE 2

De-
scriptor

slice_segment_header( ) {
...
if( !dependent_slice_segment_flag ) {
...

if( pps_loop_filter_across_slices_enabled_flag &&
( slice_sao_luma_flag | | slice_sao_chroma_flag | |

!slice_deblocking_filter_disabled_flag ) )

| | |
|---|---|
| slice_loop_filter_across_slices_enabled_flag | u(1) |
| sc_areas_enabled_flag | u(1) |
| if( sc_areas_enabled_flag ) { | |
| number_sc_areas_minus1 | u(v) |
| for( i = 0; i < number_sc_areas_minus1 + 1; i++ ) { | |

| | |
|---|---|
| sc_area_left_list_entry[i] | u(v) |
| sc_area_top_list_entry[i] | u(v) |
| sc_area_width_list_entry[i] | u(v) |
| sc_area_height_list_entry[i] | u(v) |

}
}

```
  }
  if( tiles_enabled_flag | |
  entropy_coding_sync_enabled_flag ) {
```

| | |
|---|---|
| num_entry_point_offsets | ue(v) |
| if( num_entry_point_offsets > 0 ) { | |
| offset_len_minus1 | ue(v) |
| for( i = 0; i < num_entry_point_offsets; i++ ) | |

| | |
|---|---|
| entry_point_offset_minus1[ i ] | u(v) |

}

```
  }
  if( slice_segment_header_extension_present_flag ) {
```

| | |
|---|---|
| slice_segment_header_extension_length | ue(v) |
| for( i = 0; i < slice_segment_header_extension_length; | |
| i++) | |
| slice_segment_header_extension_data_byte[ i ] | u(8) |

```
  }
  byte_alignment( )
}
```

As shown in table 2, sc_areas_enabled_flag may be set equal to 1 to specify that signaling SC areas is enabled for the slice. sc_areas_enabled_flag may be set equal to 0 to specify that no SC areas are signaled for the slice. number_sc_areas_minus 1 plus 1 may specify the number of SC areas which are signaled for the slice. sc_area_left_list_entry[i] may specify the horizontal position of the top-left pixel of the i-th SC area. sc_areas_top_list_entry[i] may specify the vertical position of the top-left pixel of the i-th SC area. sc_area_width_list_entry[i] may specify the width of the i-th SC area. sc_area_height_list_entry[i] may specify the height of the i-th SC area.

Table 3 describes specific source code that may be employed to signal partition information related to NC/SC areas as part of CU syntax via HEVC Range Extensions text specification: draft 6.

TABLE 3

| | De- |
|---|---|
| | scriptor |
| coding_unit( x0, y0, log2CbSize ) { | |
| cu_nc_area_flag | ae(v) |
| if( transquant_bypass_enabled_flag ) | |

| | |
|---|---|
| cu_transquant_bypass_flag | ae(v) |

if( slice_type != I )

| | |
|---|---|
| cu_skip_flag[ x0 ][ y0 ] | ae(v) |

nCbS = ( 1 << log2CbSize )
...
}

As shown in table 3, cu_nc_area_flag may be set equal to 1 to specify that the current CU belongs to a NC area. cu_nc_area_flag may be set equal to 0 to specify that the current CU belongs to a SC area.

Table 4 describes specific source code that may be employed to signal QP information related to NC/SC areas as part of PPS via HEVC Range Extensions text specification: draft 6.

TABLE 4

De-
scriptor

pic_parameter_set_rbsp( ) {

| | |
|---|---|
| pps_pic_parameter_set_id | ue(v) |
| pps_seq_parameter_set_id | ue(v) |
| dependent_slice_segments_enabled_flag | u(1) |
| output_flag_present_flag | u(1) |
| num_extra_slice_header_bits | u(3) |
| sign_data_hiding_enabled_flag | u(1) |
| cabac_init_present_flag | u(1) |
| num_ref_idx_l0_default_active_minus1 | ue(v) |
| num_ref_idx_l1_default_active_minus1 | ue(v) |
| init_qp_minus26 | se(v) |
| constrained_intra_pred_flag | u(1) |
| transform_skip_enabled_flag | u(1) |
| cu_qp_delta_enabled_flag | u(1) |
| if( cu_qp_delta_enabled_flag ) | |

| | |
|---|---|
| diff_cu_qp_delta_depth | ue(v) |

| | |
|---|---|
| pps_cb_qp_offset | se(v) |
| pps_cr_qp_offset | se(v) |
| pps_nc_qp_offset | se(v) |

...
}

As shown in table 4, pps_nc_qp_offset may specify the offset value for deriving a quantization parameter for NC areas. The initial NC area QP value for slice, SliceNcQp_{Y}, is derived as follows: SliceNcQp_{y}=26+init_qp_minus26+slice_qp_delta+pps_nc_qp_offset. A similar process may also be employed to specifyQP values for SC slices.

Table 5 describes a derivation process for quantization parameters that may be employed with respect to HEVC Range Extensions text specification: draft 6.

TABLE 5
...
The predicted luma quantization parameter qP_{Y}_{_{—}}_{PRED} is derived by the following ordered steps:

| | |
|---|---|
| 1. | The variable qP_{Y}_{_{—}}_{PREV} is derived as follows: |

| | |
|---|---|
| - | If one or more of the following conditions are true and if the current quantization |

group belongs to a SC area, qP_{Y}_{_{—}}_{PREV} is set equal to SliceQp_{Y}:
- The current quantization group is the first quantization group in a slice.
- The current quantization group is the first quantization group in a SC area.
- The current quantization group is the first quantization group in a tile.
- The current quantization group is the first quantization group in a coding tree

block row and entropy_coding_sync_enabled_flag is equal to 1.

| | |
|---|---|
| - | If one or more of the following conditions are true and if the current quantization |

group belongs to a NC area, qP_{Y}_{_{—}}_{PREV} is set equal to SliceNcQp_{Y}:
- The current quantization group is the first quantization group in a slice.
- The current quantization group is the first quantization group in a NC area.
- The current quantization group is the first quantization group in a tile.
- The current quantization group is the first quantization group in a coding tree

block row and entropy_coding_sync_enabled_flag is equal to 1.

| | |
|---|---|
| - | Otherwise, qP_{Y}_{_{—}}_{PREV} is set equal to the luma quantization parameter Qp_{Y} of the last |

coding unit in the previous quantization group in decoding order.

...

It should be noted that specific parameters/functions are employed in tables 1-5, some of which are not reproduced herein for the sake of clarity and brevity. However, such parameters/functions are further discussed in HEVC Range Extensions text specification: draft 6.

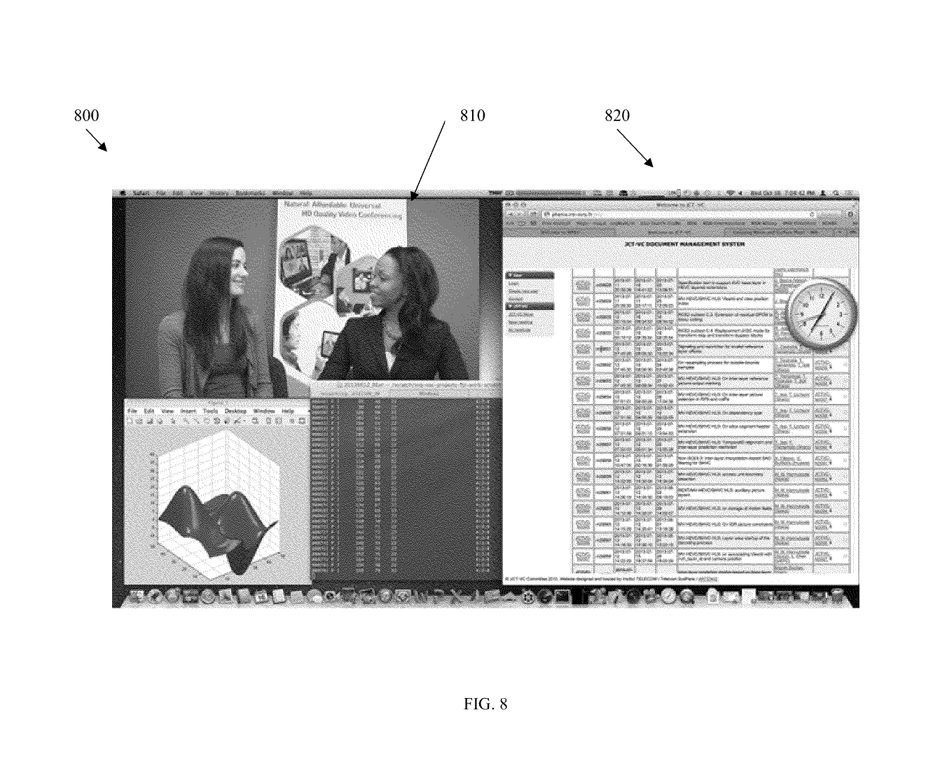

FIG. 8 illustrates another embodiment mixed content video 800 comprising SC 820 and NC 810. Mixed content video 800 may be substantially similar to mixed video content 100, and is included as a specific example of a video image that may be encoded/decoded according to methods 400, 500 and/or 600 by employing the mechanisms discussed herein. For example, mixed content video 800 may be received at steps 401 or 501 and partitioned at steps 403 or 503. SC 820 and NC 810 may be substantially similar to SC 120 and NC 110.

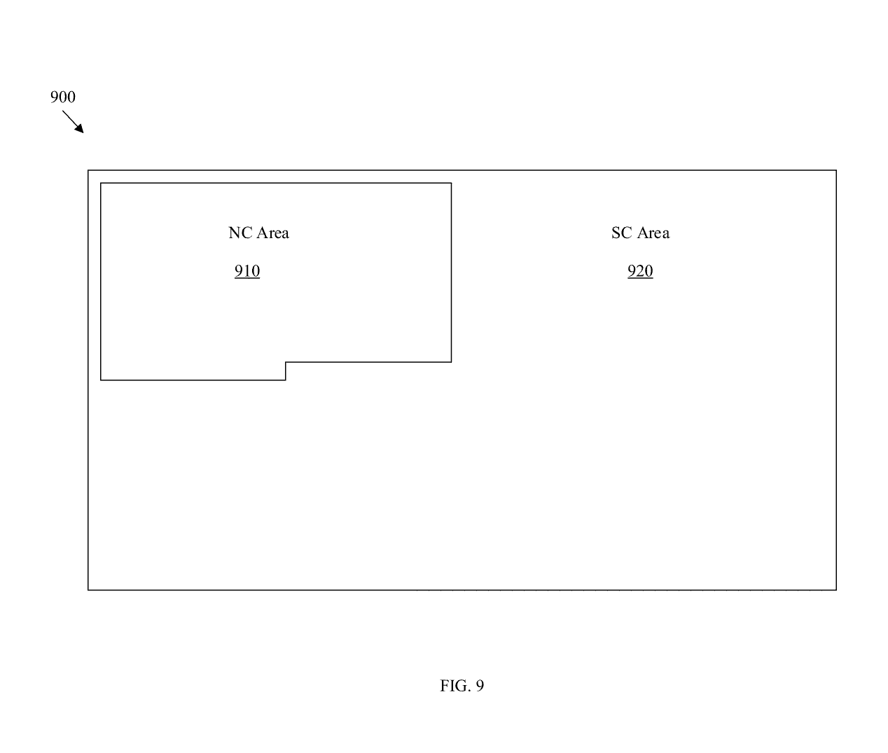

FIG. 9 is a schematic diagram of example partition information 900 associated with mixed content video 800. Upon being partitioned, mixed content video 800 comprises NC area 910 and SC area 920. As shown in in FIGS. 8-9, NC area 910 is a polygonal nonrectangular area that accurately describes NC 810, and SC area 920 is a polygonal nonrectangular area that accurately describes SC 820. NC area 910 and SC area 920 may be considered arbitrary. Accordingly, areas 910 and 920 may be encoded as arbitrary areas, mapped to a grid, and/or subdivided into additional sub-areas (e.g. a plurality of rectangular areas) as discussed above. Partition information 900 comprising NC area 910 and SC area 920 is sent to the client (e.g. client 201) to support decoding, for example in steps 409 and/or 509, or received by a client in step 601. Based on partition information 900, the client can decode the mixed content video 800.

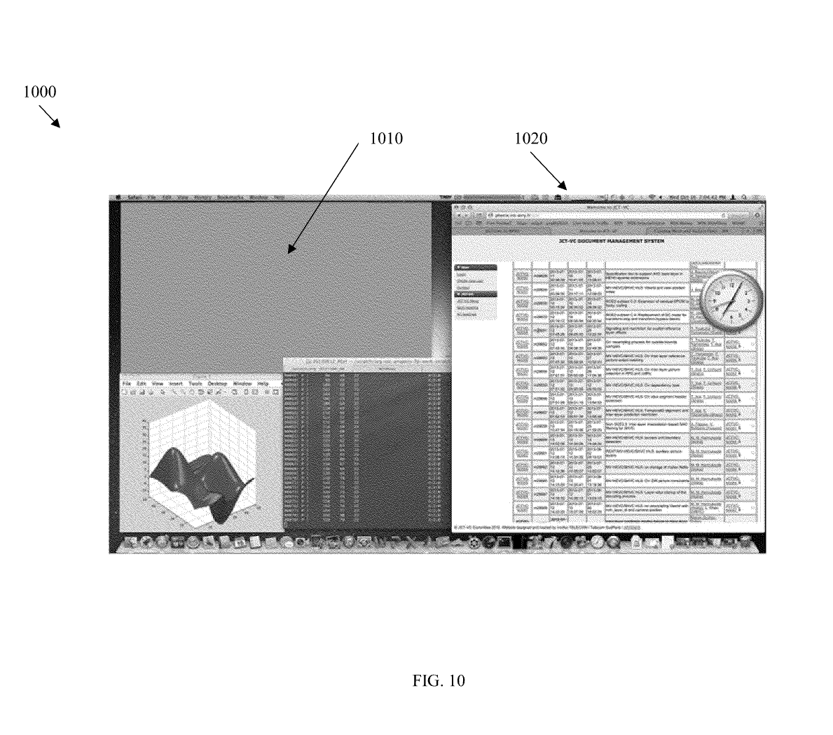

FIG. 10 illustrates an embodiment of an SC segmented image 1000 comprising SC 1020, such as the SC 820 of mixed video content 800 based on SC area 920 of partition information 900. SC segmented image 1000 may be created by steps 503 and 507. The SC segmented image 1000 comprises only the encoded SC 820 with NC 810 being replaced with a mask 1010 that may comprise a fixed value (e.g. 0) a fixed color (e.g. green) or other mask data. Accordingly, the mask 1010 is applied to the NC external to the SC to allow the SC to be encoded into the SC segmented image 1000. The SC segmented image 1000, once encoded, may be transmitted to the decoder (e.g. client 201) in an SC sub-stream.

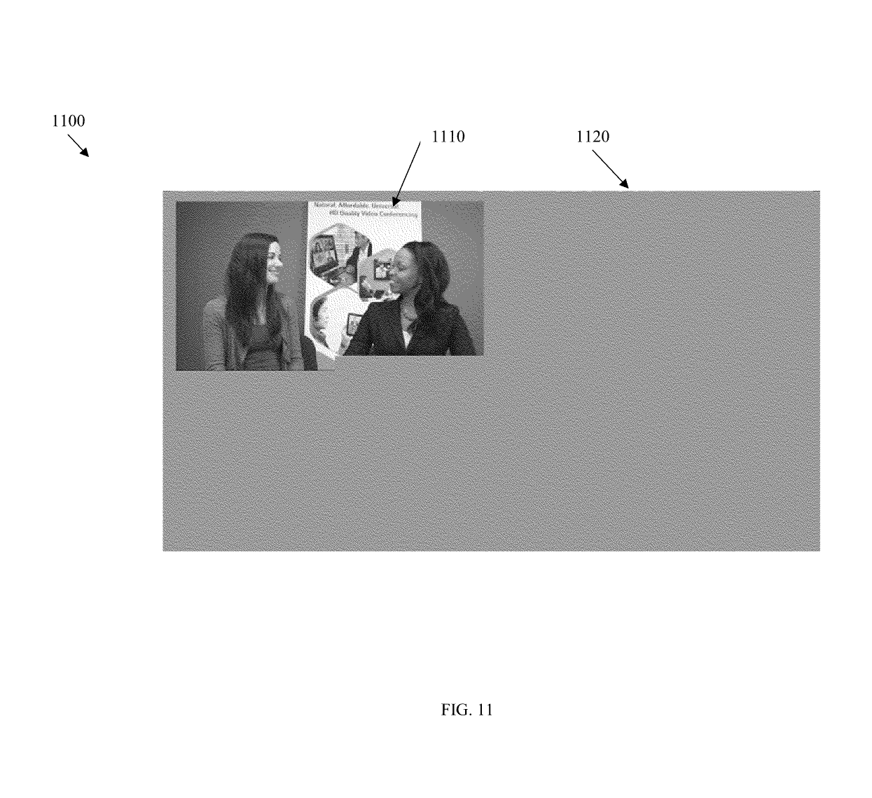

FIG. 11 illustrates an embodiment of an NC segmented image 1100 comprising NC 1110, such as the NC 810 of mixed video content 800 based on NC area 910 of partition information 900. SC segmented image may be created by step 503 and 505. The SC segmented image 1000 comprises only the encoded NC 810 with SC 810 being replaced with a mask 1120 that may comprise a fixed value (e.g. 0) a fixed color (e.g. green) or other mask data. Accordingly, the mask 1120 is applied to the SC external to the NC to allow the NC to be encoded into the NC segmented image 1100. The NC segmented image 1100, once encoded, may be transmitted to the decoder (e.g. client 201) in an NC sub-stream. It should be noted that masks 1010 and 1120 may be substantially similar or may comprise different fixed values, colors, or mask data. Upon receiving SC segmented image 1000, NC segmented image 1100, and partition information 900 (e.g. at step 601), a decoder/client may decode the SC and NC areas and combine them into a composite image equivalent to mixed content video 800 (e.g at steps 603 and 605). The composite image may then be forwarded to the display at step 607 for viewing by a user.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a processor configured to:
obtain mixed content video comprising images comprising computer generated screen content (SC) and natural content (NC);
partition the images into SC areas and NC areas; and
encode the images by encoding the SC areas with SC coding tools and encoding the NC areas with NC coding tools; and
a transmitter coupled to the processor, wherein the transmitter is configured to transmit data to a client device,
wherein the data comprises the encoded images and an indication of boundaries of the partition of the images.

2. The apparatus of claim 1, wherein the SC content comprises image content generated by a computer application, and wherein NC content comprises image content captured by an image recording device or computer generated graphical content emulating image content captured by an image recording device.

3. The apparatus of claim 1, wherein encoding the images comprises applying quantization parameters (QPs) to reduce required bandwidth to transmit the images, and wherein an SC QP value applied an SC area of a first image is different from a NC QP value applied to an NC area of the first image.

4. The apparatus of claim 3, wherein the NC QP value is greater than the SC QP value, such that a quality of the NC areas is reduced as compared with a quality of the SC areas.

5. The apparatus of claim 1, wherein each image comprises a group of subsections, and wherein the indication of boundaries of the partition for each subsection of each of the images is transmitted.

6. The apparatus of claim 1, wherein the indication of boundaries of the partition indicates a size and a location of the SC area or a size and a location of the NC area.

7. The apparatus of claim 1, wherein the indication of boundaries of the partition comprises pixel coordinates that indicate boundaries of the partition.

8. The apparatus of claim 1, wherein the images are described by coordinates quantized into a grid, and wherein the indication of boundaries of the partition comprises coordinates on the grid that indicate the boundaries of the partition.

9. The apparatus of claim 1, wherein at least one of the SC areas or NC areas comprises a non-rectangular shape, wherein partitioning the images comprises mapping the non-rectangular shape to a rectangular grid that describes an associated image comprising the non-rectangular shape.

10. The apparatus of claim 1, wherein at least one of the images comprises a subsection that comprises at least one NC pixel and at least one SC pixel, and wherein partitioning the images comprises mapping the subsection to an NC area when a ratio of NC content pixels to SC content pixels exceeds a predetermined threshold.

11. The apparatus of claim 1, wherein the indication of boundaries of the partition is transmitted in a Picture Parameter Set (PPS), in a Sequence Parameter Set (SPS), in a slice header, in Coding Unit (CU) data, in prediction unit (PU) data, in a supplemental enhancement information (SEI) message, or combinations thereof.

12. The apparatus of claim 1, wherein the indication of boundaries of the partition is transmitted at a beginning of a sequence of the images, and wherein the indication describes the partition boundaries of the sequence.

13. The apparatus of claim 12, wherein boundaries of the partition change between images, and wherein the data comprises a subsequent indication describing the change relative to a previous indication.

14. A method of decoding mixed content video at a client device, the method comprising:
receiving a bit-stream comprising encoded mixed content video comprising images, wherein each image comprises computer generated screen content (SC) and natural content (NC);
receiving, in the bit-stream, an indication of boundaries of a partition between an SC area comprising the SC content and an NC area comprising the NC content;
decoding the SC area bounded by the partition boundaries, wherein decoding the SC area comprises employing SC coding tools;
decoding the NC area bounded by the partition boundaries, wherein decoding the NC area comprises employing NC coding tools that are different from the SC coding tools; and
forwarding the decoded SC area and the decoded NC area to a display as decoded mixed content video.

15. The method of claim 14, further comprising receiving, in the bit-stream, an indication of the SC coding tools to be employed in the SC area, and an indication of the NC coding tools to be employed in the NC area.

16. The method of claim 14, further comprising receiving, in the bit-stream, an indication of NC coding tools to be disabled in the SC area and an indication of SC coding tools to be disabled in the NC area.

17. The method of claim 14, wherein the SC coding tools and the NC coding tools are selected implicitly based on the partition boundaries.

18. The method of claim 14, wherein the SC coding tools employ a first chroma sampling format for the SC area, wherein the NC coding tools employ a second chroma sampling format for the NC area, and wherein the first chroma sampling format is different from the second chroma sampling format.

19. A computer program product comprising computer executable instructions stored on a non-transitory computer readable medium such that when executed by a processor cause a network element (NE) to:
obtain mixed content video comprising images comprising computer generated screen content (SC) and natural content (NC);
partition the images into SC images containing SC and NC images containing NC;
encode the SC images into at least one SC sub-stream;
encode the NC images into at least one NC sub-stream; and
transmit, via a transmitter, the sub-streams to a client device for recombination into the mixed content video.

20. The computer program product of claim 19, wherein each image comprises a plurality of SC areas and a plurality of NC areas, wherein image data for each area is encoded into a different dedicated sub-stream, and wherein the dedicated sub-streams for the areas employ a different image resolution.

21. The computer program product of claim 19, wherein encoding the SC images into a SC sub-stream further comprises applying a mask to image data external to the SC.

22. The computer program product of claim 19, wherein encoding the NC images into a NC sub-stream further comprises applying a mask to image data external to the NC.

23. The computer program product of claim 19, wherein encoding the SC image into a sub-stream further comprises expanding a partitioned SC area and associated content to a predetermined size prior to encoding the SC image into the sub-stream.

24. The computer program product of claim 19, wherein encoding the NC image into a sub-stream further comprises expanding a partitioned NC area and associated content to a predetermined size prior to encoding the NC image into the sub-stream.
